(19) United States
(12) Patent Application Publication
(10) Pub. No.: US 2018/0162743 A1
(43) Pub. Date: Jun. 14, 2018

(54) WASTEWATER TREATMENT SYSTEM AND METHOD

(71) Applicant: Basil Mackrodt, San Jose, CA (US)

(72) Inventor: Basil Mackrodt, San Jose, CA (US)

(21) Appl. No.: 15/379,406

(22) Filed: Dec. 14, 2016

(51) Int. Cl. C02F 1/00; C02F 9/00

(52) U.S. Cl. CPC C02F 1/008; C02F 1/66; C02F 9/00

(57) ABSTRACT

The present disclosure provides for a system and method for treating a wastewater stream by measuring the level of a contaminant, adding a treatment fluid and mixing them in an inline mixer and then by means of a custom spray head inside a mixing tank. The treated effluent from the tank can be further treated in a similar fashion in successive treatment tanks before being discharged. The contaminant can be an out-of-range pH, particulate matter or dissolved metals.

### BACKGROUND OF THE INVENTION

Before being discharged, reused or recycled, wastewater must often be treated to neutralize unwanted acidity or alkalinity or to remove contaminants such as particulates or dissolved metals that may result as a byproduct of industrial or commercial activities. Facilities such as circuit board manufacturers, pharmaceutical manufacturers and other facilities where any effluent must comply with environmental regulations which govern the maximum particulate matter, turbidity, dissolved contaminants, and pH level in waste water are suitable sources of the wastewater to be treated. Current methods employed are feeding the non-compliant wastewater into a continuously stirred mixing tank where a neutralizing solution or a clarifying agent is added. The treated mixture can be discharged when contaminants or alkalinity is within the desired range. A difficulty with existing facilities that employ continuous stirring is the expense of operating the motor of the stirrer.

### SUMMARY OF THE INVENTION

The wastewater treatment system and method of the present invention is useful for treating wastewater to neutralize unwanted acidity or alkalinity or to remove contaminants such as particulates, turbidity, dissolved materials such as heavy metals, etc., from wastewater that may result as a byproduct of industrial or commercial activities. Facilities such as circuit board manufacturers, pharmaceutical manufacturers and other facilities where an effluent must comply with environmental regulations governing the maximum particulate matter and pH level in the effluent are suitable sources of the wastewater to be treated.

1 Stage—A single-stage system for treating wastewater having a pH outside of a desired range comprises an inlet pipe for a wastewater influent that has a pH outside of the range of a target pH; a sensor, located in the flow path of the influent, configured to detect the pH of the received influent; at least one injection source, located downstream from the sensor adapted to inject a treatment solution into the received influent based on the pH detected by the sensor, to perform a first treatment of the influent; an inline static mixer configured to receive the injected influent and to mix the same to at least partially neutralize the pH of the injected influent; a first treatment tank configured to hold injected influent, the tank having a riser pipe configured at one end to receive the injected influent; the riser pipe being configured at the other end with a cap having downward-facing holes along its perimeter to discharge the influent downwardly into the tank, thus causing the influent to be agitated within the treatment tank to form a homogenous first treated effluent; the tank also having an outlet pipe through which the first treated effluent is discharged.

2 Stages—A further embodiment of the system further includes a second stage of treatment comprising a second sensor, located in the discharge pipe of the first treatment tank, configured to detect the pH of the first treated effluent; at least one secondary injection source, located downstream from the second sensor and adapted to inject a neutralizing solution into the first treated effluent based on the pH detected by the second sensor, to perform a second treatment of the wastewater; a second inline static mixer configured to receive the first injected effluent and to mix the same to at least partially neutralize the pH of the injected effluent; a second treatment tank configured to hold the first injected effluent, the second tank having a second riser pipe configured at one end to receive the first injected effluent; the second riser pipe being configured at the other end with a cap having downward-facing holes along its perimeter configured to discharge the effluent downwardly into the tank, thus causing the effluent to be agitated within the tank to form a homogenous second treated effluent; the tank also having an outlet pipe through which the second treated effluent is discharged.

3+ Stages—Another embodiment of the wastewater treating system further includes more than one stage of treatment wherein each of the more than one stage of treatment includes a sensor located in the inlet pipe to each stage, one or more injection sources for a neutralizing solution located in the inlet pipe downstream of the sensor, a treatment tank having a riser pipe configured at one end to receive the injected effluent and configured at the other end with a cap that downwardly disperses treated liquid into a lower portion of the discharge tank, an inline static mixer located either in the inlet pipe downstream of the injection source or in the riser pipe, and an treated effluent discharge pipe, and each stage of treatment is configured to further treat a treated effluent from an immediate prior stage until the pH of the treated effluent is within the target pH range.

Discharge Tank—In yet another embodiment, the wastewater treating system further comprises a line configured to transport effluent from the last treatment tank to a discharge storage tank for storing treated wastewater before discharge; a sensor located either within the discharge tank or in the flow path of the effluent downstream from the last treatment tank, the sensor being configured to detect the pH of the effluent as it is discharged from the last treatment tank, or in the discharge tank; a recycle line configured to transport effluent from the last treatment tank back to the influent pipe upstream of the first sensor in the event that the pH detected by the final sensor is outside of a target range; and a valve configured to redirect the flow of the effluent from the last treatment tank to the influent pipe upstream of the first sensor in the event that the pH detected by the final sensor is outside of a target range.

Contaminant—1 tank—In still another embodiment directed to a system for treating a fluid such as a wastewater stream having a particulate contaminant or excess turbidity or dissolved substances as heavy metals, the system which comprises an inlet pipe configured to receive an influent in the form of a fluid with a contaminant; a sensor, located in the flow path of the influent, configured to detect the level of contaminant of the received influent or whether there is a flow of contaminated wastewater; at least one injection source, located downstream from the sensor, adapted to treat the influent by injecting a treatment solution into the received influent based on the reading detected by the sensor; an inline static mixer configured to receive the injected influent and to mix the same to at least partially disperse treatment solution into the injected influent; a first treatment tank configured to hold injected influent, the tank having a riser pipe configured at one end to receive the injected influent and configured at the other end with a cap having downward-facing holes along its perimeter so as to discharge the influent downwardly into the tank, thus causing the injected influent mixture to be agitated within the treatment tank to form a homogenized first treated effluent; the tank also having an outlet pipe through which the first treated effluent is discharged. Subsequent to discharge, the treated effluent will be conveyed to a facility to allow the contaminants to separate from the fluid, and the fluid and the settled contaminants can be disposed of or recycled as desired.

Method—1—In another aspect, the present invention encompasses a method of treating wastewater which comprises receiving an influent wastewater to be treated; measuring the pH of the received influent; based on the pH measurement, adding to the received influent a neutralizing solution thereby generating a first treated influent; mixing the first treated influent using a static inline mixer to form a partially mixed influent; discharging the partially mixed influent within the interior of a treatment tank through a cap having downwardly-facing holes around the perimeter thereof, to uniformly mix the treated influent within the treatment tank to generate a homogenous treated influent; holding a portion of the homogenous treated influent in the treatment tank to mix with the partially mixed influent; and discharging the homogenous treated influent as treated effluent.

Method—2 tank—In yet another aspect, the method further comprises measuring the pH of the treated effluent; based on the pH measurement, adding a neutralizing solution to the treated effluent, thereby generating a second treated influent; mixing the second treated influent using a static inline mixer to form a second partially mixed influent, discharging the second partially mixed influent within the interior of a treatment tank through a cap having downwardly-facing holes around the perimeter thereof, to uniformly mix the second treated influent within the second treatment tank to generate a second homogenous treated influent; holding a portion of the second homogenous treated influent in the second treatment tank to mix with the second partially mixed influent; and discharging homogenous second treated influent from the treatment tank as a second treated effluent.

Method—3+ tank—In yet still another aspect, the method further comprises measuring the pH of the second treated effluent; based on the pH measurement, adding to the second treated effluent a neutralizing solution thereby generating a third treated influent; using a static inline mixer, mixing the third treated influent to form a third partially mixed influent, discharging the third partially mixed influent within the interior of a treatment tank through a cap having downwardly-facing holes around the perimeter thereof, to uniformly mix the third treated influent within the treatment tank to generate a third homogenous treated influent; retaining a portion of the third homogenous treated influent in the treatment tank to mix with the third partially mixed influent; and discharging homogenous third treated influent as a third treated effluent.

Off-spec discharge recycle—In yet still another aspect, the method further comprises measuring the pH of the final treated effluent; if the pH is within an accepted range based on the pH measurement, discharging the final treated effluent; and if the pH is not within the accepted range based on the pH measurement, recycling the final treated effluent to upstream of the first pH measurement.

Method—Contaminant Removal—In still yet another aspect, the invention is a method of treating a fluid to remove contaminants comprising: receiving an influent fluid to be treated; measuring either whether there is a level of contaminant in the influent fluid or whether there is flow of influent, and if there is flow or a level of contaminant, adding to the received influent a treating solution thereby generating a first treated influent; using a static inline mixer, mixing the first treated influent to form a partially mixed influent, discharging the partially mixed influent within the interior of a treatment tank through a cap having downwardly-facing holes around the perimeter thereof, thus uniformly mixing the treated influent to generate a homogenous treated influent; holding a portion of the partially treated influent in the treatment tank to mix with the partially mixed influent to form the homogenous treated influent; and discharging the homogenous treated influent as treated effluent, which may then be sent to a settling tank where the contaminants can be separated from the clarified fluid or as otherwise desired. Alternatively, if the influent contains a measurable contaminant, the level of which can be detected by a sensor, the contaminant level can be measured and a treating solution added to the received influent based upon the level of the contaminant,

The invention will become readily apparent upon further review of the following specification and drawings.

### BRIEF DESCRIPTION OF THE DRAWINGS

FIG. 1 is an exemplary diagrammatic view of a one aspect of a one-stage contaminated wastewater treatment system according to the present invention.

FIG. 2 is an exemplary diagrammatic view of a three-stage contaminated wastewater treatment system according to the present invention.

FIG. 3 is an exemplary diagrammatic view of a one aspect of a one-stage contaminated fluid treatment system according to the present invention.

Similar reference characters denote corresponding features consistently throughout the attached drawings.

### DETAILED DESCRIPTIONS OF THE PREFERRED EMBODIMENTS

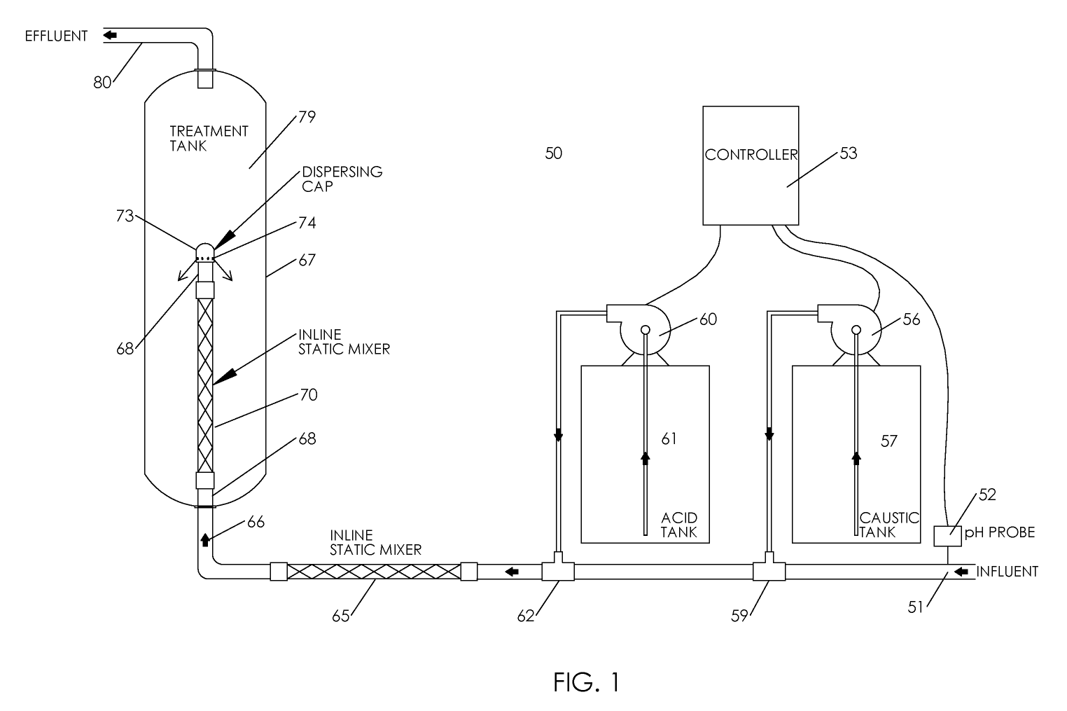

FIG. 1 represents an exemplary embodiment of the proposed contaminated wastewater treatment system 50 having a single stage. Untreated contaminated water having a pH outside of an accepted range enters the system through influent line 51, where a pH sensor 52 which generate a signal responsive to the pH of the influent. The signal from the pH sensor 52 is sent to a controller 53 which generates a signal to control the speed of one or more variable speed pumps 56 and 60, which inject either a basic neutralizing fluid from reservoir 57 or an acidic neutralizing fluid from acid reservoir 61. The control signal can be responsive to the deviation of the pH of the influent from the desired range, and the control signal can control the rate of neutralization fluid injection by means of a variable speed pump, or by means of a control valve. For example, for wastewater which is too acidic, a caustic neutralization solution is injected into the wastewater influent at 59, or if the wastewater is too basic, an acidic neutralization solution is injected at 62, to form a first injected influent.

The first injected effluent in line 51 passes through an inline static mixer 65 or 70 before entering a treatment tank 67. Note that inline static mixer 65 can be located in the inlet line 51 from which the influent passes to line 66 exterior to the treatment tank and then to riser 68 within the treatment tank. Alternatively, inline static mixer 70 can be positioned in the riser within the treatment tank. Or, inline mixers at both locations can be employed. The injected effluent from riser line 68 is discharged through cap 73 in riser 68 through downward-facing holes 74 spaced around the perimeter of the cap.

Treatment tank 67 is at least partially filled homogenized first treated influent 79, and the discharge of the first treated influent through the holes 74 in cap 73 causes the influent to be agitated within the treatment tank 67 to form a homogenous first treated effluent 79. The treatment tank 67 also has an outlet pipe 80 through which the first treated effluent is discharged.

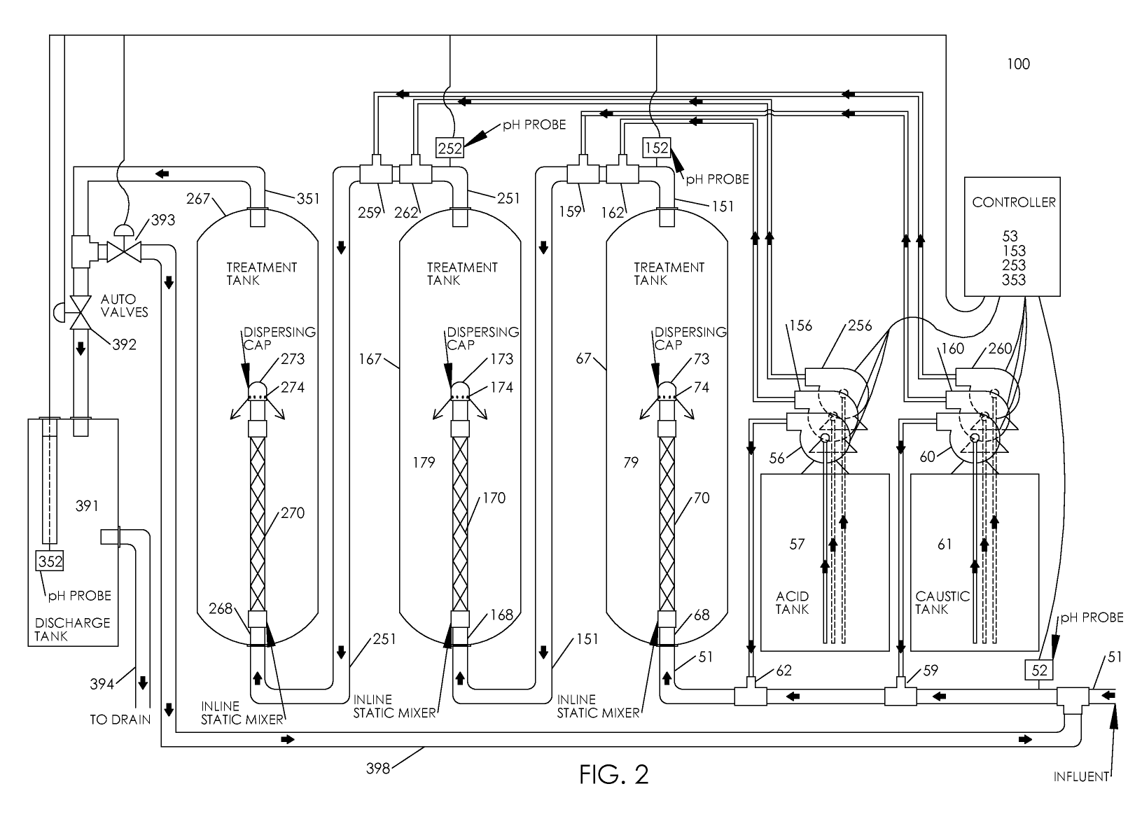

FIG. 2 represents another exemplary embodiment of the proposed contaminated wastewater treatment system 100 having three stages and a discharge tank with a recycle feature. Untreated contaminated water having a pH outside of an accepted range enters the system through influent line 51, where a pH sensor 52 sends a signal to a controller 53 which generates a signal responsive to the pH of the influent. Controller 53 has many modules, each of which can receive and send out multiple signals. Alternatively, the control functions can be carried out by individual controller modules that are physically separate. The signal from the controller 53 is used to control the speed of one or more variable speed pumps 56 and 60, which inject a neutralizing fluid from acid reservoir 57 or a caustic reservoir 61. The control signal can be responsive to the deviation of the pH of the influent from the desired range, and the control signal can control the rate of neutralization fluid injection by means of a variable speed pump, or a regular pump and control valve. For wastewater which is too acidic, a caustic neutralization solution is injected into the wastewater influent at 59; or if the wastewater is too basic, an acidic neutralization solution is injected at 62, to form a first injected influent. The first injected influent in line 51 passes into a riser 68 within treatment tank 67, the riser having an inline static mixer 70. The injected influent is ejected from the riser through cap 73 through downward-facing holes 74 spaced around the perimeter of the cap 73. In an alternative aspect, an inline static mixer can be disposed within line 51 upstream of treatment tank 67 in place of or in addition to the inline static mixer 70 within riser 68.

The first treatment tank 67 is at least partially filled with homogenized first treated influent 79, and the discharge of the first treated influent through the holes in cap 73 of riser 68 causes the influent to be agitated within the treatment tank 67 to form a homogenous first treated effluent 79; the tank 67 also has an outlet pipe 151 through which the first treated effluent is discharged.

In outlet line 151, a pH sensor 152 measures the pH of the first treated effluent and sends a signal to a controller 153 which generates a signal responsive to the pH of the influent. The signal from controller 153 is used to control the speed of one or more variable speed pumps 156 and 160, which inject a neutralizing fluid from acid reservoir 57 or a caustic reservoir 61 into outlet line 151. The control signal can be responsive to the deviation of the pH of the first treated effluent from the desired range, and the control signal can control the rate of neutralization fluid injection by means of a variable speed pump, or a regular pump and control valve, or other suitable means. For wastewater which is too basic, an acidic neutralization solution is injected from reservoir 57 into the first treated effluent at 159, or if the wastewater is too acidic, a caustic neutralization solution is injected from reservoir 61 at 162, to form a second injected influent. The second injected effluent in line 151 passes through an inline static mixer 170 after entering treatment tank 167 through a riser 168, from which the injected effluent is ejected through a cap 173 through downward-facing holes 174, spaced around the perimeter of the cap 173. In an alternative aspect, an inline static mixer can be disposed within line 151 upstream of treatment tank 167 in place of or in addition to the inline static mixer 170 disposed within the riser 168.

The second treatment tank 167 is at least partially filled with homogenized second treated influent 179, and the discharge of the second treated influent through the holes in cap 173 cause the influent to be agitated within the treatment tank 167 to form a homogenous second treated effluent 179; the tank 167 also has an outlet pipe 251 through which the second treated effluent is discharged.

In outlet line 251, a pH sensor 252 measures the pH of the second treated effluent and sends a signal to a controller 253 which generates a signal responsive to the pH of the influent. The signal from the controller is used to control the speed of one or more variable speed pumps 256 and 260, which inject a neutralizing fluid from acid reservoir 57 or a caustic reservoir 61 into outlet line 251. The control signal can be responsive to the deviation of the pH of the influent from the desired range, and the control signal can control the rate of neutralization fluid injection by means of a variable speed pump, or a regular pump and control valve or other suitable means. For wastewater which is too acidic, a caustic neutralization solution from reservoir 61 is injected into the wastewater influent at 259, or if the wastewater is too basic, an acidic neutralization solution from reservoir 57 is injected at 262, to form a third injected influent. The third injected effluent in line 251 passes through an inline static mixer 270 within riser 268 after entering treatment tank 267, from which the injected effluent is ejected through a riser cap 273 through downward-facing holes 274 spaced around the perimeter of the cap 273. In an alternative aspect, an inline static mixer can be disposed within line 251 upstream of treatment tank 267 in place of or in addition to the inline static mixer 270 within riser 268.

The third treatment tank 267 is at least partially filled with homogenized third treated influent 269, and the discharge of the third treated influent through the holes in cap 273 cause the influent to be agitated within the treatment tank 267 to form a homogenous third treated effluent 269; the tank 267 also has an outlet pipe 351 through which the third treated effluent is discharged.

Discharge tank 391 receives the effluent via outlet line 351 from the third treatment tank, and a pH sensor 352 within the discharge tank measures the pH of the third treated effluent and sends a signal to a controller 353 which generates a signal responsive to the pH of the influent. The signal from the controller 353 is used to control the flow of the third treated effluent, such that when the effluent is within accepted parameters, the flow in line 351 will be directed to discharge tank 391. If the pH of the third treated effluent is outside of accepted parameters, the controller 353 will close a valve 392 in line 351 and open valve 393 in line 351 allowing the off-spec treated effluent to be recycled to the influent line 51 for further treatment, instead of entering the discharge tank 391. As a further safety measure, there may be a pH sensor for the effluent in line 351 that will direct the flow of the effluent either to the discharge tank 391 when the pH is within accepted parameters or to the recycle line 51 and block it from flowing to the discharge tank when it is off spec. When the pH of the wastewater in the discharge tank, it is discharged to the drain vial line 394, or recycled as desired.

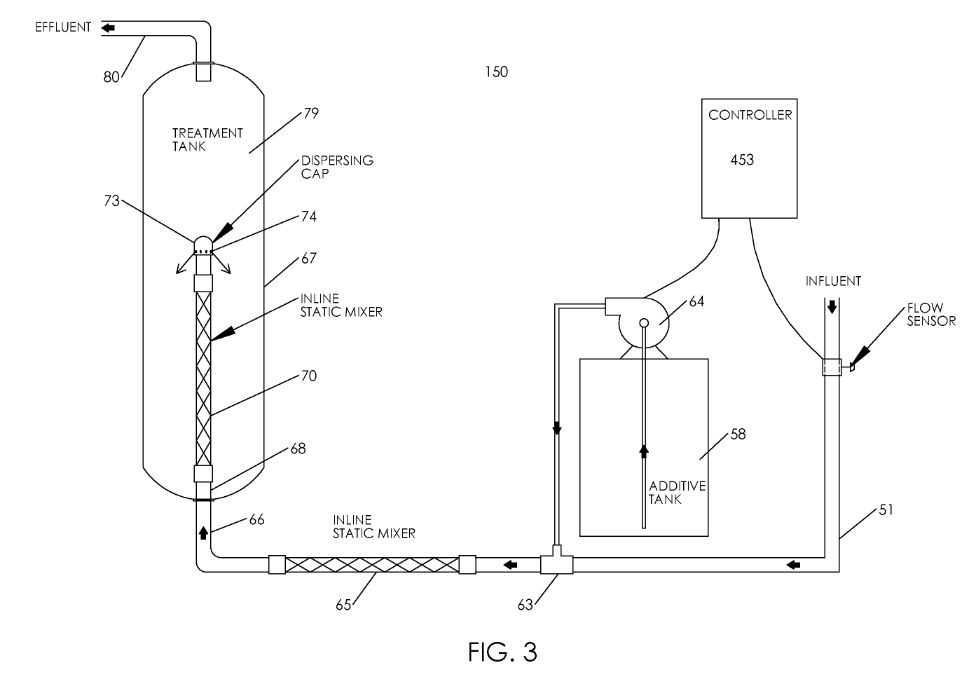

FIG. 3 represents another exemplary aspect of the proposed wastewater treatment system 150 of the present invention in which a liquid containing contaminants is treated with an additive to facilitate removal of the contaminant. Untreated contaminated wastewater having a contaminant such as a particulate or suspended or dissolved material outside of an accepted range enters the system through influent line 51, where a controller 453 generates a signal responsive to whether there is flow of an influent needing treatment. The signal from the controller 453 is used to control the speed of a variable speed pump 64, which injects an additive from additive tank 58 into the influent line 51 at 63 to form a first injected influent.

The first injected effluent in line 51 passes through an inline static mixer 65 or 70 before entering a treatment tank 67. Note that inline static mixer 65 can be located in the inlet line 51 from which the influent passes to line 66 exterior to the treatment tank, and the injected influent flows to riser 68 within the treatment tank. Alternatively, the inline static mixer 70 can be positioned in the riser 68 within the treatment tank 67. Or, inline mixers at both locations can be employed. The injected effluent from riser line 68 is discharged through dispersing cap 73 in riser 68 through downward-facing holes 74 spaced around the perimeter of the cap.

Treatment tank 67 is at least partially filled homogenized first treated influent 79, and the discharge of the first treated influent through the holes in cap 73 causes the influent to be agitated within the treatment tank 67 to form a homogenous first treated effluent 79. The treatment tank 67 also has an outlet pipe 80 through which the first treated effluent is discharged, either to a settling tank, for reuse within the facility, or discharged.

Method—treating contaminant—In another aspect of the method embodiment of the present invention, there is an influent stream of contaminated water. Typical various contaminants include chemicals, excess acidity or alkalinity outside of a given range, particulate matter, turbidity, or dissolved heavy metals. A sensor makes a measurement of the level of contaminant in the contaminated water, and a controller associated with the sensor then signals a responsive input of a neutralization fluid, such as caustic source (if the pH of the influent is below the acceptable range), or an acidic fluid (if the pH of the influent is above the acceptable range). If the contaminant is other than an out-of-range pH, and involves excess turbidity, chemical contaminant level, or particulate level, the sensor will make a measurement and an associated controller will generate a responsive signal to allow input of a neutralization fluid such as a flocculent.

By way of background, suitable acidic aqueous solutions which can be used to decrease pH of a liquid stream include, without limitation: sulfuric acid, nitric acid, hydrochloric acid, and acetic acid, among others. Suitable caustic or alkaline aqueous solutions which can be used to increase the pH of a liquid stream include, without limitation, sodium hydroxide, ammonium hydroxide.

And, a neutralization fluid for a contaminated liquid stream containing suspended or dissolved particles can contain flocculating agents, chemicals that promote flocculation by causing colloids and other suspended particles in liquids to aggregate, forming a floc. Flocculants are used in water treatment processes to improve the sedimentation or filterability of small particles. For instance, filtration to aid removal of microscopic particles which would otherwise cause the water to be turbid (cloudy) and which would be difficult or impossible to remove by filtration alone.

Many flocculants are multivalent cations such as aluminum, iron, calcium or magnesium, or sodium aluminate or sodium silicate. Natural products such as chitosan, isinglass, moringa oleifera seeds, gelatin, guar gum and alginates can also be employed. These positively charged molecules interact with negatively charged particles and molecules to reduce the barriers to aggregation. In addition, many of these chemicals, under appropriate pH and other conditions such as temperature and salinity, react with water to form insoluble hydroxides which, upon precipitating, link together to form long chains or meshes, physically trapping small particles into the larger floc. Long-chain polymer flocculants, such as modified polyacrylamides, can also be supplied as an aqueous solution to be added to the influent.

Once the neutralization fluid is added to the influent, the resulting injected influent is subject to static mixing before being discharged into a treatment tank through a specially designed cap at the end of a riser. The treatment tank is preferably oriented vertically and maintained with a volume of liquid. The injected influent passes through riser and is discharged into the liquid in the treatment tank through downwardly-angled holes spaced around the circumference of the cap of the riser. The discharged injected influent further mixes with the contents of the treatment tank, ensuring that the first injection of the neutralizing fluid is thoroughly mixed to form a homogenized first treated effluent.

Contaminant clarification—In the embodiment of clarification of contaminants, the homogenized first treated effluent is withdrawn from the treatment tank, typically at a location at or near the top of the tank, and the treated effluent is then passed to a sediment tank (not shown) where the sediment can separate from the treated clarified liquid. The clarified liquid can either be reused, discharged, or subject to further treatment.

Neutralization—one tank—In the embodiment of pH neutralization where there is just one treatment tank, the homogenized first treated effluent can be withdrawn from the treatment tank, and subject to a second pH probe. That probe will signal a controller to either send the homogenized first treated effluent to a discharge tank for release or reuse, or to recycle at least a portion of it for further treatment.

Neutralization—multiple tanks—In an embodiment of pH neutralization where there are two or more treatment tanks, the homogenized first treated effluent is withdrawn from the first treatment tank, and subject to measurement with a second pH probe. That probe will signal a controller to inject additional neutralization fluid into the homogenized first treated effluent, depending on whether the pH is above or below the desired range. Or, if the pH is within the desired range, there is no need to add additional neutralization fluid.

Once the neutralization fluid (if needed) is injected into to the first treated effluent, the resulting injected influent is subject to static mixing before being discharged into a second treatment tank through a specially designed cap at the end of the riser in the second treatment tank. The second treatment tank is oriented vertically and is preferably maintained with a full or nearly full volume of liquid. The second injected effluent passes through riser and is discharged into the liquid in the second treatment tank through downwardly-angled holes spaced around the circumference of the cap of the riser. The discharged second injected effluent further mixes with the contents of the second treatment tank, ensuring that the second injection of the neutralizing fluid is thoroughly mixed to form a homogenized second treated effluent.

In the embodiment of pH neutralization where there are two treatment tanks, the homogenized second treated effluent can be withdrawn from the treatment tank, and subject to a third pH probe. That probe will signal a controller to either send the homogenized second treated effluent to a discharge tank for release or reuse, or to recycle at least a portion of it for further treatment.

Tank 3—In an embodiment of pH neutralization where there are three or more treatment tanks, the homogenized second treated effluent is withdrawn from the second treatment tank, and subjected to measurement using a third pH probe. That probe will signal a controller which will cause injection of additional neutralization fluid into the homogenized second treated effluent, depending on whether the pH is above or below the desired range. Or, if the pH is within the desired range, there is no need to add additional neutralization fluid.

Once the third neutralization fluid is injected into to the second treated effluent, the resulting injected influent is subject to static mixing before being discharged into a third treatment tank through a specially designed cap at the end of a riser in the treatment tank. The third treatment tank is oriented vertically and is preferably maintained with a full or nearly full volume of liquid. The third injected effluent passes through riser and is discharged into the liquid contents in the third treatment tank through downwardly-angled holes spaced around the circumference of the riser cap. The discharged third injected effluent further mixes with the contents of the third treatment tank, ensuring that the third injection of the neutralizing fluid is thoroughly mixed to form a homogenized third treated effluent.

After Last Treatment Tank—In the embodiment of pH neutralization where there are multiple treatment tanks, the homogenized final treated effluent from the last treatment tank is withdrawn from the treatment tank, and subject to another pH probe. That probe will signal a controller to either send the homogenized final treated effluent to a discharge tank for release or reuse if the pH is within set parameters, or if the homogenized final treated effluent is outside of the set pH parameters, to recycle at least a portion of homogenized final treated effluent for further treatment.

In yet another embodiment, there will be a probe sensing the pH of the liquid in the discharge tank, and if the pH exceeds set parameters (typically within a narrower range than regulatory requirements), the controller responsive to the probe signal will open a valve to send the effluent of the final treatment tank back to mix with the influent upstream of the first sensor, and concurrently close the valve allowing effluent of the final treatment tank to enter the discharge tank.

It will also be appreciated that one or more of the elements depicted in the drawings/figures can also be implemented in a more separated or integrated manner, or even removed or rendered as inoperable in certain cases, as is useful in accordance with a particular application.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. In addition, in this specification and claims, the terms “line” and “pipe” are used interchangeably.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A wastewater treating system comprising:
an inlet pipe configured to receive an influent in the form of wastewater with an pH outside of a target pH range;
a sensor, located in the flow path of the influent, configured to detect the pH of the received influent;
at least one injection source, located downstream from the sensor, adapted to inject a neutralizing solution into the received influent based on the pH detected by the sensor to perform a first treatment of the influent;
an inline static mixer configured to receive the injected influent and to mix the same to at least partially neutralize the pH of the injected influent;
a first treatment tank configured to hold injected influent, the tank having a riser pipe configured at one end to receive the injected influent;
the riser pipe being configured at the other end with a cap having downward-facing holes along its perimeter to discharge the influent downwardly into the tank, thus causing the influent to be agitated within the treatment tank to form a homogenous first treated effluent;
the tank also having an outlet pipe through which the first treated effluent is discharged.

2. The wastewater treating system of claim 1, further including at least one variable speed injection pump configured to pump the neutralizing solution at a controlled rate, the controlled rate being adjusted based on the detected pH of the influent.

3. The wastewater treating system of claim 1, wherein there is a first variable speed pump to configured to inject a caustic neutralization solution into the received influent, based on the pH detected by the sensor; and a second variable speed pump to configured to inject an acidic neutralization solution into the received influent, based on the pH detected by the sensor.

4. The wastewater treating system of claim 1, wherein the inline mixer is located exterior to the treatment tank, downstream of the injection source and upstream of the riser.

5. The wastewater treating system of claim 1, wherein the inline mixer is positioned within the riser within the treatment tank and upstream of the cap.

6. The wastewater treating system of claim 1, further including a second stage comprising
a second sensor, located downstream from the first treatment tank, configured to detect the pH of the first treated effluent;
at least one secondary injection source, located downstream from the second sensor and adapted to inject a neutralizing solution into the first treated effluent based on the pH detected by the second sensor, to perform a second treatment of the wastewater;
a second inline static mixer configured to receive the first injected effluent and to mix the same to at least partially neutralize the pH of the injected effluent;
a second treatment tank configured to hold the first injected effluent, the second tank having a second riser pipe configured at one end to receive the first injected effluent;
the second riser pipe being configured at the other end with a cap having downward-facing holes along its perimeter configured to discharge the effluent downwardly into the tank, thus causing the effluent to be agitated within the tank to form a homogenous second treated effluent;
the tank also having an outlet pipe through which the second treated effluent is discharged.

7. The wastewater treating system of claim 6, further including at least one variable speed injection pump configured to pump the neutralizing solution at a controlled rate, the controlled rate being adjusted based on the detected pH of the influent.

8. The wastewater treating system of claim 6, wherein there is a first variable speed injection device configured to inject a caustic neutralization solution into the received influent, based on the pH detected by the sensor; and a second variable speed injection device configured to inject an acidic neutralization solution into the received influent, based on the pH detected by the sensor.

9. The wastewater treating system of claim 6, further including a caustic injection device configured to inject a basic neutralization solution from the caustic injection source and an acidic injection device configured to inject either an acidic neutralization solution from the acidic injection source based on the detected acidity of the influent stream.

10. The wastewater treating system of claim 6, wherein the inline mixer is located exterior to the treatment tank, downstream of the injection source and upstream of the riser.

11. The wastewater treating system of claim 6, wherein the inline mixer is positioned within the riser within the treatment tank and upstream of the cap.

13. The treating wastewater system of claim 1, further including more than one stage of treatment wherein each of the more than one stage of treatment includes a sensor, an injection source for a neutralizing solution, an inline static mixer, a treatment tank having a riser with a cap that downwardly disperses treated liquid and an treated effluent discharge pipe, and each stage of treatment is configured to further treat a treated effluent from an immediate prior stage until the pH of the treated effluent is within the target pH range.

14. The wastewater treating system of claim 1 further comprising
a pipe configured to transport effluent from the last treatment tank to a discharge storage tank for storing treated wastewater before discharge;
a final sensor located in the discharge tank, the sensor being configured to detect the pH of the effluent;
a recycle line configured to transport effluent from the last storage tank upstream of the discharge tank, back to the influent pipe upstream of the first sensor in the event that the pH detected by the final sensor is outside of a target range;
a valve configured to redirect the flow of the effluent from the last treatment tank to the influent pipe upstream of the first sensor in the event that the pH detected by the final sensor is outside of a target range.

15. A contaminated fluid treating system comprising:
an inlet pipe configured to receive an influent in the form of a fluid with a contaminant;
a sensor, located in the flow path of the influent, configured to detect the level of contaminant of the received influent or the flow of the influent;
at least one injection source, located downstream from the sensor, adapted to inject a treatment solution into the received influent based on the reading detected by the sensor to perform a treatment of the influent;
an inline static mixer configured to receive the injected influent and to mix the same to at least partially disperse treatment solution into the injected influent;
a first treatment tank configured to hold injected influent, the tank having a riser pipe configured at one end to receive the injected influent;
the riser pipe being configured at the other end with a cap having downward-facing holes along its perimeter to discharge the influent downwardly into the tank, and causing the injected influent mixture to be agitated within the treatment tank to form a homogenized first treated effluent;
the tank also having an outlet pipe through which the first treated effluent is discharged.

16. A method of treating wastewater comprising:
receiving an influent wastewater to be treated;
measuring the pH of the received influent;
based on the pH measurement, adding a neutralizing solution to the received influent, thereby generating a first treated influent;
using a static inline mixer, mixing the first treated influent to form a partially mixed influent,
discharging the partially mixed influent within the interior of a treatment tank through a cap having downwardly-facing holes around the perimeter thereof, to uniformly mix the treated influent within the treatment tank to generate a homogenous treated influent;
holding a portion of the homogenous treated influent in the treatment tank to mix with the partially mixed influent discharged through the cap; and
discharging the homogenous treated influent as treated effluent.

17. The method of claim 16 further comprising
measuring the pH of the mixed influent; and
depending on how far the measured pH is outside of a desired range, injecting either an acid neutralizing solution or a basic neutralizing solution at a rate of injection of the neutralizing solution controlled by a variable-speed pump or a metering valve to facilitate matching the pH of the mixed influent with a target pH.

18. The method of claim 16 further comprising
measuring the pH of the treated effluent;
based on the pH measurement, adding to the treated effluent, a neutralizing solution thereby generating a second treated influent;
using a static inline mixer, mixing the second treated influent to form a second partially mixed influent,
discharging the second partially mixed influent within the interior of a treatment tank through a riser having a cap with downwardly-facing holes around the perimeter thereof, to uniformly mix the second treated influent within the treatment tank to generate a second homogenous treated influent;
holding a portion of the second homogenous treated influent in the treatment tank to mix with the second partially mixed influent; and
discharging the homogenous second treated influent as a second treated effluent.

19. The method of claim 18 further comprising
measuring the pH of the second treated effluent;
based on the pH measurement, adding to the second treated effluent, a neutralizing solution thereby generating a third treated influent;
using a static inline mixer, mixing the third treated influent to form a third partially mixed influent,
discharging the third partially mixed influent within the interior of a treatment tank through a riser having a cap with downwardly-facing holes around the perimeter thereof, to uniformly mix the third treated influent within the treatment tank to generate a third homogenous treated influent;
holding a portion of the third homogenous treated influent in the treatment tank to mix with the third partially mixed influent; and
discharging the homogenous third treated influent as a third treated effluent.

20. The method of claim 16 further comprising
measuring the pH of the final treated effluent;
if the pH is within the accepted range based on the pH measurement, discharging the final treated effluent;
if the pH is not within the accepted range based on the pH measurement, recycling the final treated effluent to upstream of the first pH measurement.

21. A method of treating a fluid to remove contaminants comprising:
receiving an influent fluid to be treated;
measuring the level of contamination of the received influent;
based on the measurement of the contamination level, adding to the received influent a treating solution thereby generating a first treated influent;
using a static inline mixer, mixing the first treated influent to form a partially mixed influent,
discharging the partially mixed influent within the interior of a treatment tank through a cap having downwardly-facing holes around the perimeter thereof, to uniformly mix the treated influent to generate a homogenous treated influent;
holding a portion of the partially treated influent in the treatment tank to mix with the partially mixed influent;
discharging the homogenous treated influent as treated effluent.
